(19) United States
(12) Patent Application Publication
(10) Pub. No.: US 2011/0121210 A1
(43) Pub. Date: May 26, 2011

(54) Digital output circuit

(75) Inventors: Hiroyuki Oono, Kobe-shi (JP); Takahiro Yoshida, Osaka-shi (JP); Kuniaka Matsuura, Ibaraki-shi (JP)

(73) Assignee: Panasonic Electric Works SUNX Co., Ltd., Aichi (JP)

(21) Appl. No.: 12/926,535

(22) Filed: Nov. 24, 2010

(30) Foreign Application Priority Data
Nov. 25, 2009 (JP) 2009-268063

(51) Int. Cl. G02B 27/00

(52) U.S. Cl. 250/551

(57) ABSTRACT

A digital output circuit includes a photocoupler, having one light emitting diode and one phototransistor, for transmitting a digital voltage output signal to the load; an output transistor, having a control terminal, a first terminal and second terminals, for transmitting an output signal from the phototransistor to the load; and a voltage smoothing unit. Further, a first terminal of the phototransistor is connected to a power supply terminal via a first resistor and a second terminal of the phototransistor is connected to the control terminal of the output transistor. A second resistor is connected between the control terminal and the first terminal of the output transistor. The first terminal of the output transistor is connected to the common terminal and the second terminal of the output transistor is connected to the output terminal. The voltage smoothing unit is connected between the first terminal of the phototransistor and the common terminal.

### FIELD OF THE INVENTION

The present invention relates to a digital output circuit for use in, e.g., a programmable logic controller (PLC).

### BACKGROUND OF THE INVENTION

Generally, a PLC is widely used in control of various external apparatuses. Recently, an external apparatuses to be controlled tend to have complicated configurations, requiring input/output signals to be processed at a high speed.

There is proposed a general purpose PLC unit which includes, as shown in FIG. 3, an external connector 15′ to which an external apparatus to be controlled is connected, a connection connector 16′ to which a CPU unit having a CPU for executing, e.g., a sequence program is connected, a programmable logic device (PLD) 17′ for performing sequence control of the external apparatus based on the sequence program executed by the CPU, and a display unit 18′ having, e.g., light emitting diodes for displaying an operational state of the PLC unit. The PLC unit further includes an isolation unit 19′ provided between the external connector 15′ and the PLD 17′ and having plural photocouplers for transmitting input and output signals while electrically isolating the external connector 15′ and the PLD 17′ from each other, a setting switch 20′ for setting an operational state of the PLD 17′, and a power supply unit 21′ for supplying electric power to the PLD 17′, the display unit 18′, isolation unit 19′ and the setting switch 20′ (see, e.g., Japanese Patent Application Publication No. 2002-222003). Further, the PLD 17′ is provided with a microcomputer (hereinafter, simply referred to as “micom”) for detecting an input signal from the external apparatus or outputting an output signal to the external apparatus.

In the general purpose PLC unit having a configuration shown in FIG. 3, a high speed photocoupler having a high response speed compared to a general purpose photocoupler composed of one light emitting diode and one phototransistor may be used as a photocoupler of the isolation unit 19′ serving as a digital input/output circuit. In such a case, the PLC unit can be responsive to the voltage level of the output signal outputted from the PLD 17′ rapidly and repeatedly varying between high and low levels. However, the high speed photocoupler is more expensive compared to the general purpose photocoupler, making it difficult to realize the digital input/output circuit at a low cost.

Accordingly, there is proposed a digital output circuit 1 using a general purpose photocoupler. The digital output circuit 1 includes, e.g., a light emitting diode LD6 of the general purpose photocoupler that is connected to an internal circuit 11 of the PLC 2 for processing an output signal outputted to an output apparatus (external apparatus) L1 serving as a load, a phototransistor PT8 of the general purpose photocoupler that is switched on and off according to on and off of the light emitting diode LD6, and a transistor TR13 for transmitting the output signal outputted from the phototransistor PT8 to the output apparatus L1, as shown in FIG. 4, (see, e.g., Japanese Patent Application Publication No. 2000-224021). Further, the photocoupler described above is formed of a package that includes the light emitting diode LD6 and the phototransistor PT8 facing the light emitting diode LD6.

In the digital output circuit 1 shown in FIG. 4, the collector terminal of the phototransistor PT8 is connected to a power supply terminal T3 connected to the positive side of a power supply V1, and the emitter terminal of the phototransistor PT8 is connected to the common terminal T5 connected to the negative side of the power supply Vi via a series circuit of a resistor R4 and a resistor R2. Further, the connection node between the resistor R2 and the resistor R4 connected to the emitter terminal of the phototransistor PT8 is connected to the base terminal of the transistor TR13. The collector terminal of the transistor TR13 is connected to an output terminal T4 for outputting an output signal to the output apparatus L1. The emitter terminal of the transistor TR13 is connected to the connection node between the resistor R2 and the common terminal T5. Further, a series circuit of the output apparatus L1 and the power supply V1 is connected between the output terminal T4 and the common terminal T5. The connection node between the output apparatus L1 and the positive side of the power supply V1 is connected to the power supply terminal T3.

Hereinafter, an operation of the digital output circuit 1 shown in FIG. 4 will be described.

For example, if the voltage level of the output signal outputted from the internal circuit 11 is changed from low to high, the light emitting diode LD6 is turned on and an electric current Il flows in the light emitting diode LD6 of the photocoupler. Resultantly, the phototransistor PT8 is switched on (i.e., becomes in an ON state). The base-emitter of the transistor TR13 is biased at a potential of the connection node between the resistor R4 and the resistor R2 and the transistor TR13 is turned on. Thus, an electric current 12 flows from the power supply V1 to the output apparatus L1.

On the other hand, if the voltage level of the output signal outputted from the internal circuit 11 is changed from high to low, the light emitting diode LD6 is turned off and the electric current Il does not flow in the light emitting diode LD6 of the photocoupler. As a result, the phototransistor PT8 is switched off (i.e., becomes in an OFF state), and thus the base-emitter of the transistor TR13 is not biased. Accordingly, the transistor TR13 is also turned off and the electric current 12 does not flow from the power supply V1 to the output apparatus L1.

Further, there is proposed another digital output circuit using a general purpose photocoupler. The digital output circuit includes, e.g., a light emitting diode LD6 of a general purpose photocoupler PC5 that is connected between the positive side of a power supply (control power supply of a microcomputer 10) Vcc and an output port T1 of the microcomputer 10 provided in the PLC, a phototransistor PT8 of the general purpose photocoupler PC5 that is switched on and off according to on and off of the light emitting diode LD6, and a transistor TR13 for transmitting the output signal outputted from the phototransistor PT8 to a load L, as shown in FIG. 5. Further, the above-described photocoupler PC5 is formed of a package that includes the light emitting diode LD6 and the phototransistor PT8 facing the light emitting diode LD6.

In the digital output circuit shown in FIG. 5, the anode of the light emitting diode LD6 of the photocoupler PC5 is connected to the positive side of the power supply Vcc. The cathode of the light emitting diode LD6 is connected to the output port T1 of the microcomputer 10 via a resistor R1. Further, the collector terminal of the phototransistor PT8 of the photocoupler PC5 is connected to a power supply terminal T3 connected to the positive side of a power supply V1 via a resistor R3 for biasing the base of the transistor TR13. The emitter terminal of the phototransistor PT8 is connected to the base terminal of the transistor TR13, and a resistor R2 is connected between the base terminal and the emitter terminal of the transistor TR13. Further, the collector terminal of the transistor TR13 is connected to an output terminal T4 for outputting an output signal to the load L, and the emitter terminal of the transistor TR13 is connected to the common terminal T5 connected to the negative side of the power supply V1. Further, a series circuit of the load L and a power supply V2 for the load L is connected between the output terminal T4 and the common terminal T5.

Hereinafter, an operation of the digital output circuit shown in FIG. 5 will be described.

For example, if the voltage level of the output signal outputted from the microcomputer 10 is changed from high to low (an active state in which the voltage level of the output port T1 of the microcomputer 10 is a low level), the light emitting diode LD6 is turned on and an electric current Il flows in the light emitting diode LD6 of the photocoupler PC5. Resultantly, the phototransistor PT8 is switched on (i.e., becomes in an ON state). The base-emitter of the transistor TR13 is biased at a potential of the connection node between the resistor R2 and the emitter terminal of the phototransistor PT8 and the transistor TR13 is turned on. Thus, an electric current 12 flows from the power supply V2 to the load L. On the other hand, if the voltage level of the output signal outputted from the microcomputer 10 is changed from low to high, the light emitting diode LD6 is turned off and the electric current Il does not flow in the light emitting diode LD6 of the photocoupler PC5. As a result, the phototransistor PT8 is switched off (i.e., becomes in an OFF state), and thus the base-emitter of transistor TR13 is not biased. Accordingly, the transistor TR13 is turned off and the electric current 12 does not flow from the power supply V2 to the load L.

However, in the digital output circuits having the circuit configurations shown in FIGS. 4 and 5, the phototransistor PT8 becomes in a saturated state when the phototransistor PT8 is in the ON state. Accordingly, when the state of the phototransistor PT8 is switched from an ON state to an OFF state, a response delay occurs due to the mirror effect of the phototransistor PT8 and long accumulation time of the base-emitter capacitance of the phototransistor PT8 (base storage time). Thus, if the voltage level of the output signal (of high speed pulse) outputted from the microcomputer 10 repeatedly varies at a high speed, it is difficult to accurately switch the voltage level of the output signal from the PLC between high and low levels. Therefore, it is preferable to use a photocoupler having high response speed rather than a general purpose photocoupler in order to make a response to the high speed pulse output. However, it is difficult to realize the circuit at a low cost with the photocoupler having high response speed.

Further, in order to realize a high response speed using a general purpose photocoupler, a digital output circuit having a circuit configuration shown in FIG. 6 may be considered in which the resistor R3 for biasing the base of the transistor TR13 is removed and the power supply V1 is directly connected to the collector terminal of the phototransistor PT8 in the digital output circuit shown in FIG. 5. In the digital output circuit shown in FIG. 6, the potential of the collector terminal of the phototransistor PT8 is fixed at a voltage level of the power supply V1 supplied to the phototransistor PT8. Further, since the emitter terminal of the phototransistor PT8 is connected to the base terminal of the transistor TR13, the potential of the emitter terminal of the phototransistor PT8 is also fixed when the phototransistor PT8 is in an ON state. Consequently, the collector-emitter voltage of the phototransistor PT8 does not become 0 V, and thus the phototransistor PT8 is in an unsaturated state.

Further, since the collector-emitter voltage swing of the phototransistor PT8 is small, a mirror effect of the phototransistor PT8 hardly occurs. Accordingly, a switching operation can be performed while the phototransistor PT8 is not in the saturated state and the collector-emitter voltage of the phototransistor PT8 hardly varies. Further, the response delay, which occurs due to the mirror effect and base storage time of the phototransistor PT8, can be shortened when the state of the phototransistor PT8 is changed from an ON state to an OFF state. Consequently, it is possible to accurately switch the voltage level of the high speed pulse output signal from the microcomputer 10 between high and low levels by using the general purpose photocoupler PC5 including one light emitting diode LD6 and one phototransistor PT8 even though the photocoupler having high response speed is not used as a signal transmitting element. Further, there is an effect of minimizing the number of circuit elements in the digital output circuit.

However, in the digital output circuit shown in FIG. 6, there is no resistor R3 for biasing the base of the transistor TR13 (see FIG. 5). Therefore, if the voltage level of the power supply V1 supplied to the phototransistor PT8 is high, a heat dissipation rate of the photocoupler PC5 is high and it may cause a breakdown of the photocoupler PC5 due to overheat or degrade the characteristics (e.g., a current transmission rate) of the photocoupler PC5, thereby reducing the reliability. In order to solve the problems, if the resistor R3 is provided between the collector terminal of the phototransistor PT8 and the power supply terminal T3 as in the digital output circuit shown in FIG. 5, the distributed heat dissipation can be achieved. However, as described above, the potential of the collector terminal of the phototransistor PT8 varies in the digital output circuit shown in FIG. 5 when the state of the phototransistor PT8 is switched between an ON state and an OFF state. Accordingly, the mirror effect of the phototransistor PT8 occurs and the response time when the state of the phototransistor PT8 is switched from an ON state to an OFF state becomes elongated.

### SUMMARY OF THE INVENTION

In view of the above, the present invention provides a digital output circuit capable of realizing a high response speed at a low cost and enhancing the reliability.

In accordance with a first embodiment of the present invention, there is provided a digital output circuit including: a photocoupler serving as a signal transmitting element for transmitting a digital voltage output signal from an output port of a microcomputer to a load and having one light emitting diode and one phototransistor; and an npn bipolar transistor for transmitting an output signal from the phototransistor to the load by a switching operation of the phototransistor.

Further, an anode of the light emitting diode is connected to a positive side of a first power supply, and a cathode of the light emitting diode is connected to the output port; a collector of the phototransistor is connected to a power supply terminal connected to a positive side of a second power supply via a first resistor; an emitter of the phototransistor is connected to a base of the npn bipolar transistor, and a second resistor is connected between the base and an emitter of the npn bipolar transistor; the emitter of the npn bipolar transistor is connected to a common terminal connected to a negative side of the second power supply and a collector of the npn bipolar transistor is connected to an output terminal for outputting an output signal from the npn bipolar transistor to the load; a series circuit of the load and a power supply for the load is connected between the output terminal and the common terminal; and a capacitor is connected between the collector terminal of the phototransistor and the common terminal.

In this configuration, the capacitor is provided between the common terminal and the collector terminal of the phototransistor of the photocoupler. Accordingly, when the state of the phototransistor is switched between an ON state and an OFF state, for example, while the output signal outputted from the output port of the microcomputer repeatedly is a high speed pulse output signal, the potential of the collector terminal of the phototransistor is maintained approximately constant by a smoothing effect of the capacitor. Accordingly, the collector-emitter voltage of the phototransistor is maintained substantially constant. Thus, the phototransistor is in an unsaturated state when the phototransistor is in an ON state and a switching operation of the npn bipolar transistor can be performed while the collector-emitter voltage of the phototransistor varies within a small range. As a result, a response delay, which occurs due to the mirror effect of the phototransistor and long accumulation time of the base-emitter capacitance of the phototransistor, can be shortened when the state of the phototransistor is changed from an ON state to an OFF state.

It is possible to accurately follow the change in the voltage level of the high speed pulse output signal from the microcomputer between high and low levels by using the general purpose photocoupler including one light emitting diode and one phototransistor even though a photocoupler having high response speed is not used as a signal transmitting element. Therefore, it is possible to realize a high response speed by adding an inexpensive general purpose circuit element such as the capacitor (realize a high response speed at a low cost) and realize a digital output circuit having high reliability.

In accordance with a second embodiment of the present invention, there is provided a digital output circuit including: a photocoupler serving as a signal transmitting element for transmitting a digital voltage output signal from an output port of a microcomputer to a load and having one light emitting diode and one phototransistor; and a pnp bipolar transistor for transmitting an output signal from the phototransistor to the load by a switching operation of the phototransistor.

Further, an anode of the light emitting diode is connected to a positive side of a first power supply, and a cathode of the light emitting diode is connected to the output port; an emitter of the phototransistor is connected to a power supply terminal connected to a negative side of a second power supply via a first resistor; a collector of the phototransistor is connected to a base of the pnp bipolar transistor, and a second resistor is connected between the base and an emitter of the pnp bipolar transistor; the emitter of the pnp bipolar transistor is connected to a common terminal connected to a positive side of the second power supply and a collector of the pnp bipolar transistor is connected to an output terminal for outputting an output signal from the pnp bipolar transistor to the load; a series circuit of the load and a power supply for the load is connected between the output terminal and the common terminal; and a capacitor is connected between the emitter terminal of the phototransistor and the common terminal.

In this configuration, the capacitor is provided between the common terminal and the emitter terminal of the phototransistor of the photocoupler. Accordingly, when the state of the phototransistor is switched between an ON state and an OFF state, for example, while the output signal outputted from the output port of the microcomputer repeatedly is a high speed pulse output signal, the potential of the emitter terminal of the phototransistor is maintained approximately constant by a smoothing effect of the capacitor. Accordingly, the collector-emitter voltage of the phototransistor is maintained substantially constant. Thus, the phototransistor is in an unsaturated state when the phototransistor is in an ON state and a switching operation of the pnp bipolar transistor can be performed while the collector-emitter voltage of the phototransistor varies within a small range. As a result, a response delay, which occurs due to the mirror effect of the phototransistor and long accumulation time of the base-emitter capacitance of the phototransistor, can be shortened when the state of the phototransistor is changed from an ON state to an OFF state.

It is possible to accurately follow the change in the voltage level of the high speed pulse output signal from the microcomputer between high and low levels by using the general purpose photocoupler including one light emitting diode and one phototransistor even though a photocoupler having high response speed is not used as a signal transmitting element. Therefore, it is possible to realize a high response speed by adding an inexpensive general purpose circuit element such as the capacitor (realize a high response speed at a low cost) and realize a digital output circuit having high reliability.

In accordance with the embodiments of the present invention, there is an effect of providing a digital output circuit capable of realizing a high response speed at a low cost and enhancing the reliability.

### BRIEF DESCRIPTION OF THE DRAWINGS

The objects and features of the present invention will become apparent from the following description of embodiments given in conjunction with the accompanying drawings, in which:

FIG. 1 illustrates a circuit diagram showing a digital output circuit in accordance with a first embodiment of the present invention;

FIG. 2 illustrates a circuit diagram showing a digital output circuit in accordance with a second embodiment of the present invention;

FIG. 3 illustrates a block diagram of a conventional general purpose PLC unit;

FIG. 4 illustrates a circuit diagram showing a conventional digital output circuit;

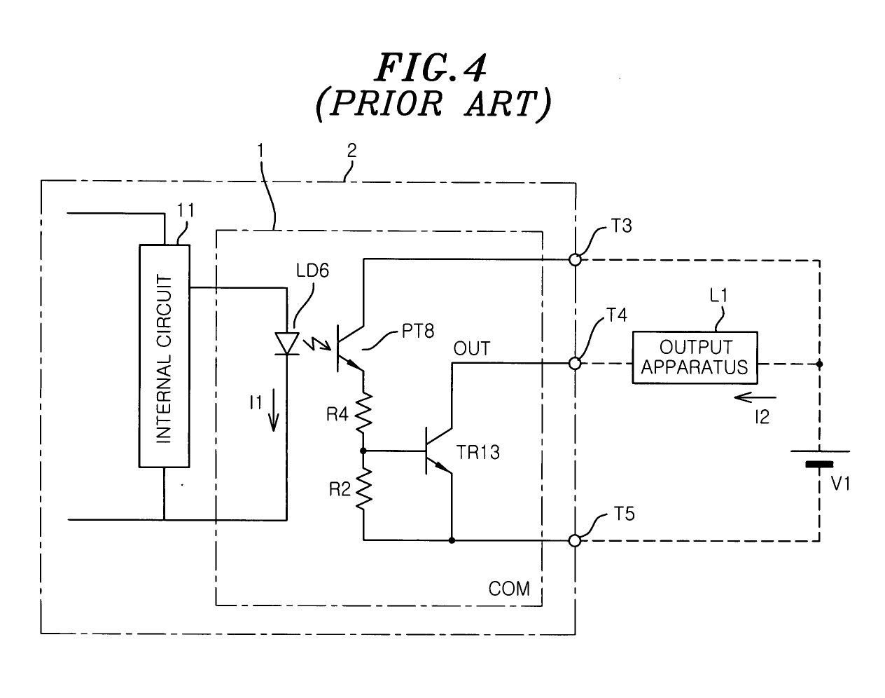

FIG. 5 illustrates a circuit diagram showing another conventional digital output circuit; and

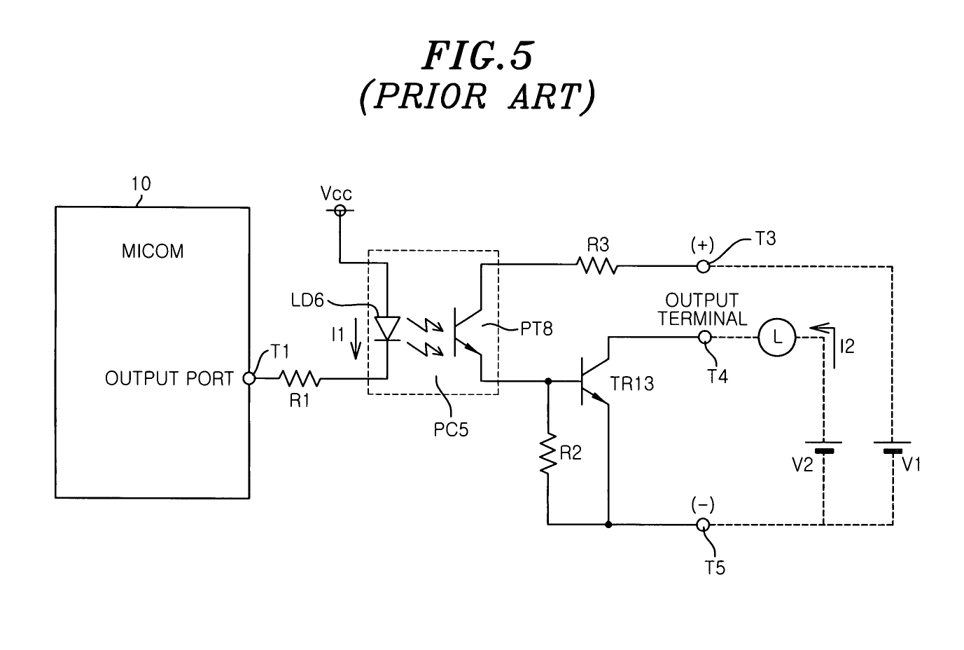

FIG. 6 illustrates a circuit diagram showing still another conventional digital output circuit.

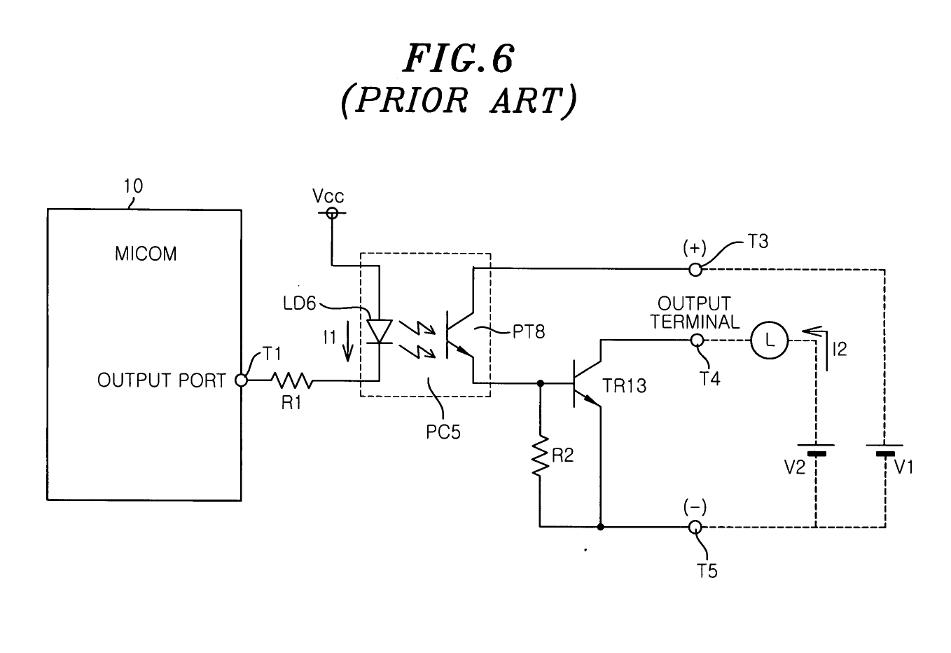

### DETAILED DESCRIPTION OF THE EMBODIMENTS

Embodiments of the present invention will be described with reference to the accompanying drawings which form a part hereof.

### First Embodiment

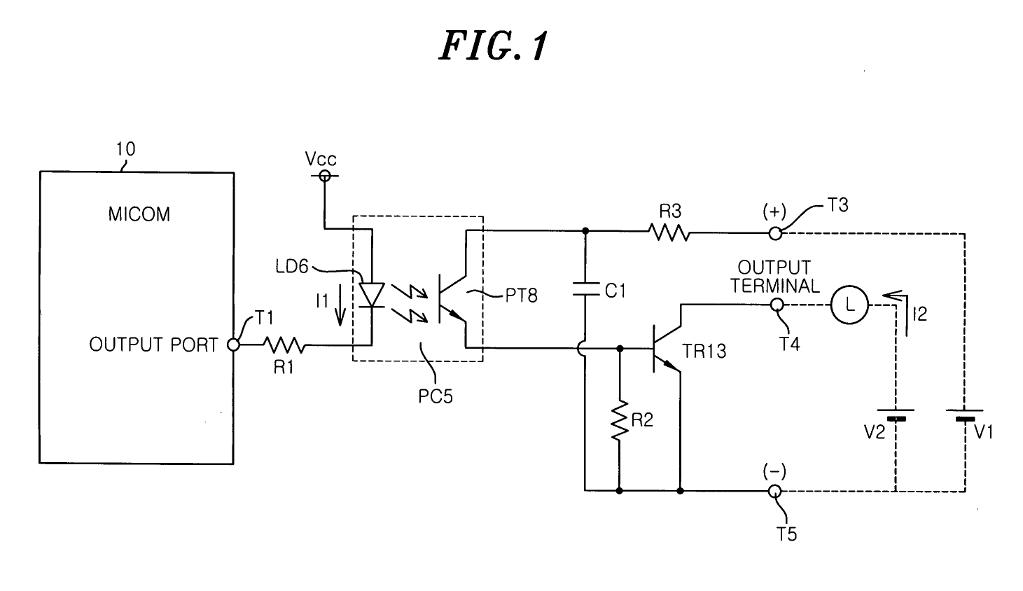

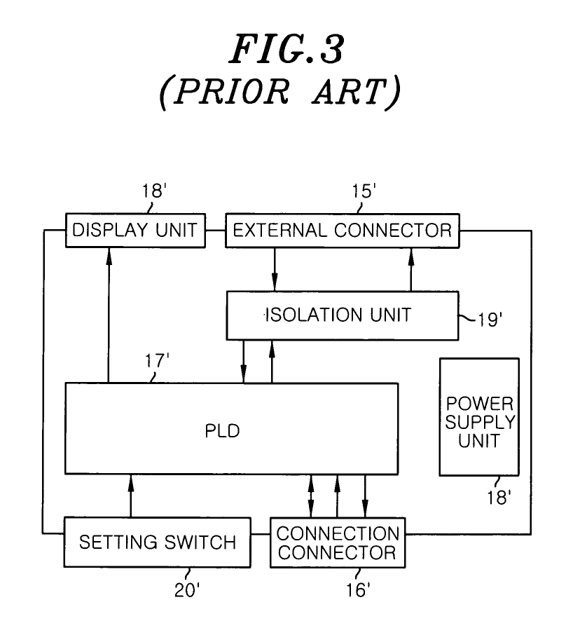

A digital output circuit in accordance with a first embodiment of the present invention may be used in, e.g., the isolation unit 19′ of the programmable logic controller (PLC) unit shown in FIG. 3, and includes a general purpose photocoupler serving as a signal transmitting element and having one light emitting diode and one phototransistor. Specifically, the digital output circuit includes, as shown in FIG. 1, a general purpose photocoupler PC5 serving as a signal transmitting element for transmitting a digital voltage output signal from a microcomputer (hereinafter, simply referred to as “micom”) 10 to a load L and having one light emitting diode LD6 and one phototransistor PT8; and a general purpose bipolar transistor TR13 for transmitting an output signal from the phototransistor PT8 to the load L by a switching operation of the phototransistor PT8 of the photocoupler PC5. A capacitor C1 (e.g., an aluminum electrolytic capacitor, a multilayer ceramic capacitor or the like) for smoothing potential variation at the collector terminal of the phototransistor PT8 is provided between the collector terminal of the phototransistor PT8 and the common terminal T5 connected to the negative side of a power supply

The micom 10 includes an output port T1 for outputting an output signal to the load L. Further, the photocoupler

PC5 is formed of a package (e.g., a resin package or the like) includes the light emitting diode LD6 serving as a light emitting element and the phototransistor PT8 serving as a light receiving element facing the light emitting diode LD6. The output signal is transmitted while the light emitting diode LD6 and the phototransistor PT8 are electrically isolated from each other.

In the digital output circuit, the anode of the light emitting diode LD6 of the photocoupler PC5 is connected to the positive side of the power supply Vcc, and the cathode of the light emitting diode LD6 is connected to the output port T1 of the micom 10 via a resistor R1. The collector terminal of the phototransistor PT8 of the photocoupler PC5 is connected to a power supply terminal T3 connected to the positive side of the power supply V1 via a resistor R3 for biasing the base of the npn type transistor TR13. The capacitor C1 is connected between the collector terminal of the phototransistor PT8 and the common terminal T5. Further, the emitter terminal of the phototransistor PT8 is connected to the base terminal of the transistor TR13, and a resistor R2 is connected between the base terminal and the emitter terminal of the transistor TR13. The collector terminal of the transistor TR13 is connected to an output terminal T4 for outputting an output signal from the transistor TR13 to the load L, and the emitter terminal of the transistor TR13 is connected to the common terminal T5. Further, a series circuit of the load L and a power supply V2 for the load L is connected between the output terminal T4 and the common terminal T5.

Further, in the first embodiment, the power supply Vcc serves as a first power supply and the power supply V1 serves as a second power supply while the resistor R3 serves as a first resistor and the resistor R2 serves as a second resistor.

Hereinafter, an operation of the digital input circuit in accordance with the first embodiment of the present invention will be described.

For example, if the voltage level of the output signal outputted from the output port T1 of the micom 10 is changed from high to low (an active state in which the voltage level of the output port T1 of the micom 10 is a low level), the light emitting diode LD6 is turned on and an electric current Il flows in the light emitting diode LD6 of the photocoupler PC5. As a result, the phototransistor PT8 is switched on. The base-emitter of the transistor TR13 is biased at a potential of the connection node between the resistor R2 and the emitter terminal of the phototransistor PT8. The transistor TR13 is turned on and an electric current 12 flows from the power supply V2 to the load L.

If the voltage level of the output signal outputted from the output port T1 of the micom 10 is changed from low to high, the light emitting diode LD6 is turned off and an electric current Il does not flow in the light emitting diode LD6 of the photocoupler PC5. Thus, the phototransistor PT8 is switched off. If the phototransistor PT8 becomes in an OFF state, the base-emitter of the transistor TR13 is not biased. Accordingly, the transistor TR13 is also turned off and an electric current 12 does not flow from the power supply V2 to the load L.

The digital output circuit described above is configured to include the capacitor C1 connected between the common terminal T5 and the collector terminal of the phototransistor PT8 of the photocoupler PC5. Accordingly, when the state of the phototransistor PT8 is switched between an ON state and an OFF state, for example, while the voltage level of the output signal (of high speed pulse) outputted from the output port T1 of the micom 10 repeatedly varies at a high speed, the potential of the collector terminal of the phototransistor PT8 is maintained approximately constant by a smoothing effect of the capacitor C1. Accordingly, the collector-emitter voltage of the phototransistor PT8 is maintained substantially constant. Thus, the phototransistor PT8 is in an unsaturated state when the phototransistor PT8 is in an ON state and a switching operation of the bipolar transistor TR13 can be performed while the collector-emitter voltage of the phototransistor PT8 varies within a small range. As a result, a response delay, which occurs due to the mirror effect of the phototransistor PT8 and the base storage time of the phototransistor PT8, can be shortened when the state of the phototransistor PT8 is changed from an ON state to an OFF state.

In the digital output circuit of the first embodiment, a switching operation can be performed while the phototransistor PT8 is not in a saturated state and the collector-emitter voltage of the phototransistor PT8 varies within a small range. Accordingly, the response delay, which occurs due to the mirror effect of the phototransistor PT8 and base storage time of the phototransistor PT8, can be shortened when the state of the phototransistor PT8 is changed from an ON state to an OFF state. Consequently, it is possible to accurately follow the change in the voltage level of the high speed pulse output signal from the micom 10 between high and low levels by using the general purpose photocoupler PC5 including one light emitting diode LD6 and one phototransistor PT8 even though a photocoupler having high response speed is not used as a signal transmitting element. Therefore, it is possible to realize a high response speed at a low cost by adding an inexpensive general purpose circuit element such as the capacitor C1 and realize a digital output circuit having high reliability.

### Second Embodiment

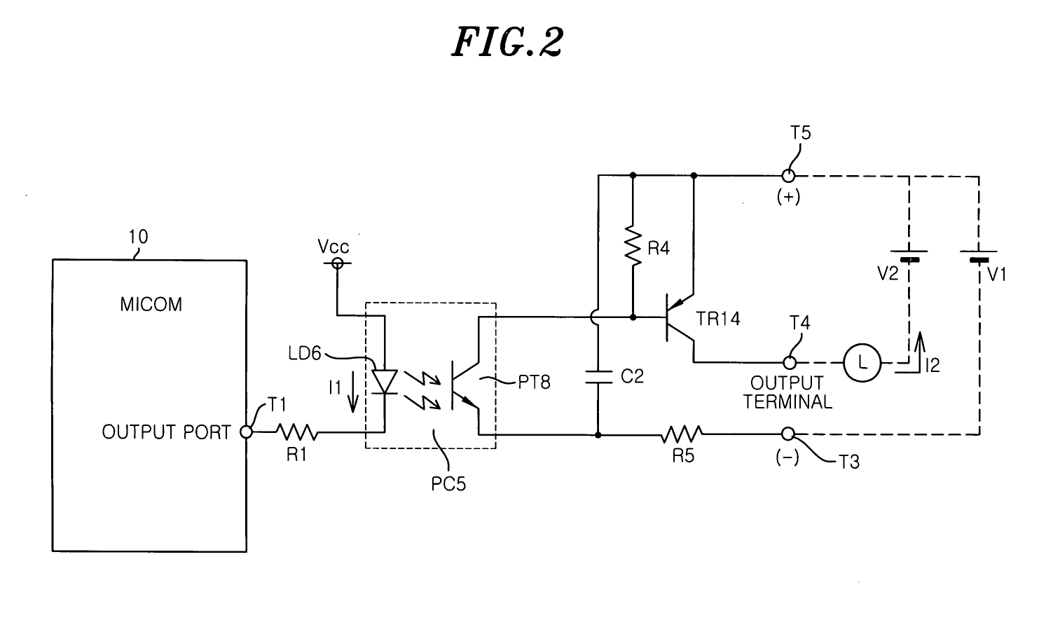

A digital output circuit in accordance with a second embodiment of the present invention may be used in, e.g., the isolation unit 19′ of the PLC unit shown in FIG. 3, and includes a general purpose photocoupler serving as a signal transmitting element and having one light emitting diode and one phototransistor. Specifically, the digital output circuit includes, as shown in FIG. 2, the general purpose photocoupler PC5 serving as the signal transmitting element for transmitting a digital voltage output signal from the micom 10 of PLC to the load L and having one light emitting diode LD6 and one phototransistor PT8; and a general purpose bipolar transistor TR14 for transmitting an output signal from the phototransistor PT8 to the load L by a switching operation of the phototransistor PT8 of the photocoupler PC5. A capacitor C2 (e.g., an aluminum electrolytic capacitor, a multilayer ceramic capacitor or the like) for smoothing potential variation at the emitter terminal of the phototransistor PT8 is provided between the emitter terminal of the phototransistor PT8 and the common terminal T5 connected to the positive side of a power supply V1.

The micom 10 includes an output port T1 for outputting an output signal to the load L. Further, the photocoupler PC5 is formed of a package (e.g., a resin package or the like) includes the light emitting diode LD6 serving as a light emitting element and the phototransistor PT8 serving as a light receiving element facing the light emitting diode LD6. The output signal is transmitted while the light emitting diode LD6 and the phototransistor PT8 are electrically isolated from each other.

In the digital output circuit, the anode of the light emitting diode LD6 of the photocoupler PC5 is connected to the positive side of the power supply Vcc, and the cathode of the light emitting diode LD6 is connected to the output port T1 of the micom 10 via a resistor R1.

The emitter terminal of the phototransistor PT8 of the photocoupler PC5 is connected to the power supply terminal T3 connected to the negative side of the power supply V1 via a resistor R5 for biasing the base of the pnp type transistor TR14. The capacitor C2 is connected between the emitter terminal of the phototransistor PT8 and the common terminal T5. Further, the collector terminal of the phototransistor PT8 is connected to the base terminal of the transistor TR14, and a resistor R4 is connected between the base terminal and the emitter terminal of the transistor TR14. The collector terminal of the transistor TR14 is connected to the output terminal T4 for outputting an output signal from the transistor TR14 to the load L, and the emitter terminal of the transistor TR14 is connected to the common terminal T5. Further, a series circuit of the load L and a power supply V2 is connected between the output terminal T4 and the common terminal T5. Further, in the second embodiment, the power supply Vcc serves as a first power supply and the power supply V1 serves as a second power supply while the resistor R5 serves as a first resistor and the resistor R4 serves as a second resistor.

Hereinafter, an operation of the digital input circuit in accordance with the second embodiment of the present invention will be described.

For example, if the voltage level of the output signal outputted from the output port T1 of the micom 10 is changed from high to low (an active state in which the voltage level of the output port T1 of the micom 10 is a low level), the light emitting diode LD6 is turned on and an electric current Il flows in the light emitting diode LD6 of the photocoupler PC5. Resultantly, the phototransistor PT8 is switched on. The base-emitter of the transistor TR14 is biased at a potential of the connection node between the resistor R4 and the collector terminal of the phototransistor PT8. The transistor TR14 is turned on and an electric current 12 flows from the power supply V2 to the load L.

If the voltage level of the output signal outputted from the output port T1 of the micom 10 is changed from low to high, the light emitting diode LD6 is turned off and an electric current Il does not flow in the light emitting diode LD6 of the photocoupler PC5. Thus, the phototransistor PT8 is switched off. If the phototransistor PT8 becomes in an OFF state, the base-emitter of the transistor TR14 is not biased. Accordingly, the transistor TR14 is also turned off and an electric current 12 does not flow from the power supply V2 to the load L.

The digital output circuit described above is configured to include the capacitor C2 connected between the common terminal T5 and the emitter terminal of the phototransistor PT8 of the photocoupler PC5. Accordingly, when the state of the phototransistor PT8 is switched between an ON state and an OFF state, for example, while the output signal of high speed pulse is outputted from the output port T1 of the micom 10, the potential of the emitter terminal of the phototransistor PT8 is maintained approximately constant by a smoothing effect of the capacitor C2. Accordingly, the collector-emitter voltage of the phototransistor PT8 is maintained substantially constant. Thus, the phototransistor PT8 is in an unsaturated state when the phtotransistor PT8 is an ON state and a switching operation of the bipolar transistor TR14 can be performed while the collector-emitter voltage of the phototransistor PT8 varies within a small range. As a result, a response delay, which occurs due to the mirror effect of the phototransistor PT8 and the base storage time of the phototransistor PT8, can be shortened when the state of the phototransistor PT8 is changed from an ON state to an OFF state.

In the digital output circuit of the second embodiment, a switching operation can be performed while the phototransistor PT8 is in an unsaturated state and the collector-emitter voltage of the phototransistor PT8 varies within a small range. Accordingly, the response delay, which occurs due to the mirror effect of the phototransistor PT8 and the base storage time of the phototransistor PT8, can be shortened when the state of the phototransistor PT8 is changed from an ON state to an OFF state. Consequently, it is possible to accurately follow the change in the voltage level of the high speed pulse output signal from the micom 10 between high and low levels by using the general purpose photocoupler PC5 including one light emitting diode LD6 and one phototransistor PT8 even though a photocoupler having high response speed is not used as a signal transmitting element. Therefore, it is possible to realize a high response speed at a low cost by adding an inexpensive general purpose circuit element such as the capacitor C2 and realize a digital output circuit having high reliability.

While the invention has been shown and described with respect to the embodiments, it will be understood by those skilled in the art that various changes and modification may be made without departing from the scope of the invention as defined in the following claims.

What is claimed is:

1. A digital output circuit comprising:
a photocoupler serving as a signal transmitting element for transmitting a digital voltage output signal from an output port of a microcomputer to a load and having one light emitting diode and one phototransistor; and
an npn bipolar transistor for transmitting an output signal from the phototransistor to the load by a switching operation of the phototransistor,
wherein an anode of the light emitting diode is connected to a positive side of a first power supply, and a cathode of the light emitting diode is connected to the output port,
wherein a collector of the phototransistor is connected to a power supply terminal connected to a positive side of a second power supply via a first resistor,
wherein an emitter of the phototransistor is connected to a base of the npn bipolar transistor, and a second resistor is connected between the base and an emitter of the npn bipolar transistor,
wherein the emitter of the npn bipolar transistor is connected to a common terminal connected to a negative side of the second power supply and a collector of the npn bipolar transistor is connected to an output terminal for outputting an output signal from the npn bipolar transistor to the load,
wherein a series circuit of the load and a power supply for the load is connected between the output terminal and the common terminal, and
wherein a capacitor is connected between the collector of the phototransistor and the common terminal.

2. A digital output circuit comprising:
a photocoupler serving as a signal transmitting element for transmitting a digital voltage output signal from an output port of a microcomputer to a load and having one light emitting diode and one phototransistor; and
a pnp bipolar transistor for transmitting an output signal from the phototransistor to the load by a switching operation of the phototransistor,
wherein an anode of the light emitting diode is connected to a positive side of a first power supply, and a cathode of the light emitting diode is connected to the output port,
wherein an emitter of the phototransistor is connected to a power supply terminal connected to a negative side of a second power supply via a first resistor,
wherein a collector of the phototransistor is connected to a base of the pnp bipolar transistor, and a second resistor is connected between the base and an emitter of the pnp bipolar transistor,
wherein the emitter of the pnp bipolar transistor is connected to a common terminal connected to a positive side of the second power supply and a collector of the pnp bipolar transistor is connected to an output terminal for outputting an output signal from the pnp bipolar transistor to the load,
wherein a series circuit of the load and a power supply for the load is connected between the output terminal and the common terminal, and
wherein a capacitor is connected between the emitter of the phototransistor and the common terminal.

3. A digital output circuit comprising:
an output terminal for outputting an output signal to a load;
a power supply terminal connected to a power supply;
a common terminal;
a photocoupler serving as a signal transmitting element for transmitting a digital voltage output signal to the load and having one light emitting diode and one phototransistor having a first and a second terminal;
an output transistor, having a control terminal, a first terminal and a second terminal, for transmitting an output signal from the phototransistor to the load by a switching operation of the phototransistor; and
a voltage smoothing unit,
wherein the first terminal of the phototransistor is connected to the power supply terminal via a first resistor and the second terminal of the phototransistor is connected to the control terminal of the output transistor,
wherein a second resistor is connected between the control terminal and the first terminal of the output transistor,
wherein the first terminal of the output transistor is connected to the common terminal and the second terminal of the output transistor is connected to the output terminal, and
wherein the voltage smoothing unit is connected between the first terminal of the phototransistor and the common terminal.

4. The digital output circuit of claim 3, wherein the voltage smoothing unit is a capacitor.
